(19) United States
(12) Patent Application Publication
(10) Pub. No.: US 2025/0002113 A1
(43) Pub. Date: Jan. 2, 2025

(54) SUSPENSION FORK AND STEM

(71) Applicant: Euphree, Inc., Houston, TX (US)

(72) Inventor: Daniel BASALDUA, Houston, TX (US)

(21) Appl. No.: 18/517,333

(22) Filed: Nov. 22, 2023

Related U.S. Application Data
(60) Provisional application No. 63/524,451, filed on Jun. 30, 2023.

(51) Int. Cl. B62K 25/08; B62K 3/02; B62L 3/02

(52) U.S. Cl. CPC B62K 25/08; B62K 3/02; B62L 3/02

(57) ABSTRACT

A suspension fork assembly includes a steer tube with a first and second end. An adjustable stem is attached to the first end. A set of legs are connected to the second end that house a compressible suspension component. The adjustable stem includes an opening, and the steer tube includes a channel extending through its sidewall. A vehicle with the suspension fork assembly above also includes a frame with a head tube, handlebars connected to the adjustable stem, and a brake line that extends through the adjustable stem opening, between the steer tube and the head tube, into the channel, and out the second end. A method of assembling a steering assembly includes forming a channel in a steer tube, coupling the steer tube second end to a crown, inserting the steer tube into a head tube, and coupling a steer tube first end to an adjustable stem.

### CROSS REFERENCE TO RELATED APPLICATIONS

This application claims priority to the following U.S. Provisional Patent Application Ser. No. 63/524,451 filed Jun. 30, 2023, which is hereby incorporated herein by reference in its entirety for all purposes.

### TECHNICAL FIELD

The present disclosure relates in general to the field of bicycle steering and braking mechanisms, and more particularly to a suspension fork assembly with internally routed brake lines.

### BACKGROUND

Bicycles are human powered vehicles that generally include handlebars connected to a fork assembly, and the fork assembly connected to a frame assembly via a head tube. A rear wheel is attached to the frame and a front wheel is attached to the legs of the fork assembly. On many bicycles, both the front and rear wheel are stopped via hand-operated braking systems.

Hand-operated braking systems, like the kinds typically incorporated in bicycles, generally include one or more brake levers connected to one or more brake calipers by brake lines. The brake levers are typically mounted to the handlebars and the brake calipers are mounted to the frame for the rear wheel and to the fork assembly for the front wheel, and the calipers are configured to clamp down on the rim of a wheel or on a brake disk at the center of the wheel. The brake lines, which are typically surrounded in a flexible sleeve, transmit a braking force generated at the brake lever to a corresponding brake caliper.

Typically, the front brake line connecting the brake lever and front brake caliper drops down from the handlebars and is anchored to the front of the front fork before connecting to the brake caliper. The front brake line has a sufficient length to accommodate a full range of motion of the handlebars. However, the exposed front brake line is less aesthetically pleasing, prevents mounting of accessories to the front of the bicycle (e.g., baskets), and can occasionally snag on nearby objects. Accordingly, what is needed in the art are unique systems and related methods that assist in the routing of front brake lines in an unconventional manner that do not suffer from deficiencies found in the prior art. The disclosed principles provide such unique systems and methods.

### SUMMARY

Novel aspects of the present disclosure are directed to a suspension fork assembly that includes a steer tube with a first end separated from a second end by an elongated body. An adjustable stem is attached to the first end and is configured to be securely fastened to handlebars. The fork assembly also includes a set of legs connected to the second end by a crown, wherein: the set of legs houses a compressible suspension component, the adjustable stem includes an opening sized to receive at least one wire, and the steer tube includes a channel extending through a sidewall of the steer tube that is sized to receive a brake line.

Novel aspects of the present disclosure are also directed to a vehicle that includes a suspension fork assembly as disclosed herein, a frame with a head tube that is coaxially aligned with the steer tube, handlebars that are connected to the adjustable stem, and a brake line that extends from the handlebars and passes into an annular region between the steer tube and the head tube. The brake line enters the steer tube through a channel and exits from the second end.

Novel aspects of the present disclosure are further directed to a method of assembling a steering assembly that includes the steps of forming a channel in a sidewall of a steer tube, wherein the channel is sized to receive a brake line; coupling a second end of the steer tube to a crown attached to a set of legs housing a compressible suspension component; inserting the steer tube into a head tube of a frame; and coupling a first end of the steer tube to an adjustable stem.

Other aspects, embodiments and features of the inventive principles disclosed herein will become apparent from the following detailed description of the inventive principles when considered in conjunction with the accompanying figures. In the figures, each identical, or substantially similar component that is illustrated in various figures is represented by a single numeral or notation. For purposes of clarity, not every component is labeled in every figure. Nor is every component of each embodiment of an apparatus, system or method in accordance with the disclosed inventive principles shown where illustration is not necessary to allow those of ordinary skill in the art to understand the inventive principles.

### BRIEF DESCRIPTION OF THE DRAWINGS

The novel features believed characteristic of the disclosed inventive principles are set forth in the appended claims. Embodiments of The inventive principles themselves, however, as well as preferred modes of use, further objectives and advantages thereof, will be best understood by reference to the following detailed description of illustrative embodiments when read in conjunction with the accompanying figures, wherein:

FIG. 1 is a view of a vehicle with a steer tube of a fork assembly in a head tube in accordance with an illustrative embodiment;

FIG. 2 is a partial cutaway view of a steer tube of a fork assembly in accordance with an illustrative embodiment;

FIGS. 3A-3D are cross-sectional views of a channel in a steer tube in accordance with illustrative embodiments;

FIG. 4 is an underside view of a steer tube of a fork assembly in accordance with an illustrative embodiment; and

FIG. 5 is a flowchart of a process for assembling a steering assembly in accordance with an illustrative embodiment.

### DETAILED DESCRIPTION

The following detailed description includes exemplary embodiments of the inventive principles disclosed herein, and reference is made to the accompanying figures that form a part hereof. The figures here are shown to only illustrate specific embodiments in which the disclosed principles may be practiced. It must be understood, however, that other embodiments may be implemented that include structural changes and modifications made without departing from the scope of the disclosed principles.

As road bicycles have started to become more aerodynamic over the last 10 years, bicycle manufacturers have begun concealing the brake lines internally to provide a cleaner look and to reduce drag. Brake lines are easier to conceal on a stiff fork because of the lack of a compression segment found on afront suspension fork. An adjustable stem also adds an additional pivot point where brake lines can be pinched. The combination of a suspension fork and an adjustable stem results in a difficult engineering challenge to route brake lines inside the head tube.

One challenge for internally routing brake lines comes from the use of adjustable stems to secure the handlebars. Adjustable stems allow the user to adjust the angle and height of the handlebars to their liking. It is difficult to route brake lines internally because the front brake line must travel through the adjustable stem on a pivot point and then through the head tube. The pivot on the adjustable stem adds complexity because the front brake lines cannot be pinched because pinched brake lines compromise braking integrity. The cramped interior of the steer tube also provides little flex if the cables are strained. The head tube must be designed to hold the front fork and stem in place, and provide freedom of movement for the front fork/handlebar without pinching any of the wires that are routed through the head tube. To date, no bicycles with adjustable stems route the brake line(s) internally.

Another challenge for internal brake line routing comes from suspension forks. Suspension forks include a compressible suspension component that absorbs impact shocks during use. To absorb the impacts, the front fork moves back and forth against the stanchions. This linear movement has caused issues with previous attempts to internally route brake lines through the front fork.

Current attempts at internal brake line routing in suspension forks use a double-cylinder steer tube. The brake lines are routed in the region between the two cylinders, which protects the brake lines from the rotational strain between the steer tube and the head tube. A suspension front fork will require a hole in the steer tube or a custom fork using a double-cylinder method whereby the front brake line exits the front fork outside of the steer tube on the side. While this approach successfully conceals brake lines within the steer tube, the additional cylinder in the steer tube adds weight, complexity, and cost to the suspension fork.

Suspension forks provide valuable shock absorbance that improves the riding experience of the user. Likewise, adjustable stems allow the user to adjust the handlebars to their liking. It is desirable to improve the aerodynamic characteristics and aesthetics of vehicles. It is also desirable to reduce the weight, complexity, and cost of vehicle components. Therefore, there is a need for an alternative internal brake line routing solution beyond the double-cylinder steer tube, and a need for an internal brake line routing solution for a suspension fork with an adjustable stem.

Novel aspects of this disclosure recognize that a single-walled steer tube with a hole passing through its sidewall can still provide sufficient structural integrity. Thus, the single-walled steer tube with a hole for receiving the brake line can be used to route a brake line through the head tube and then through the steer tube without the need for a double-walled steer tube. The double-walled steer tube is more costly and complex to make, and adds unnecessary weight.

It should be noted that, as used in the specification and the appended claims, the terms “forward,” “front,” “ahead,” and similar refer to the direction ahead of a user operating a vehicle with the described components herein. Likewise, the terms “backward,” “rear,” “behind,” and similar refer to the direction behind a user operating a vehicle with described components herein. The two types of terms thus refer to opposite directions of each other.

It should also be noted that, as used in the specification and the appended claims, the singular forms “a,” “an,” and “the” include plural references unless the context clearly dictates otherwise. References to a composition containing “a” constituent is intended to include other constituents in addition to the one named. Also, in describing the preferred embodiments, terminology will be resorted to for the sake of clarity. It is intended that each term contemplates its broadest meaning as understood by those skilled in the art and includes all technical equivalents, which operate in a similar manner to accomplish a similar purpose.

Also, the use of terms herein such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” is intended to be open-ended and to reflect that structure, material, or acts are not necessary, the failure to use such terms is not intended to reflect that structure, material, or acts are essential. To the extent that structure, material, or acts are presently considered to be essential, they are identified as such.

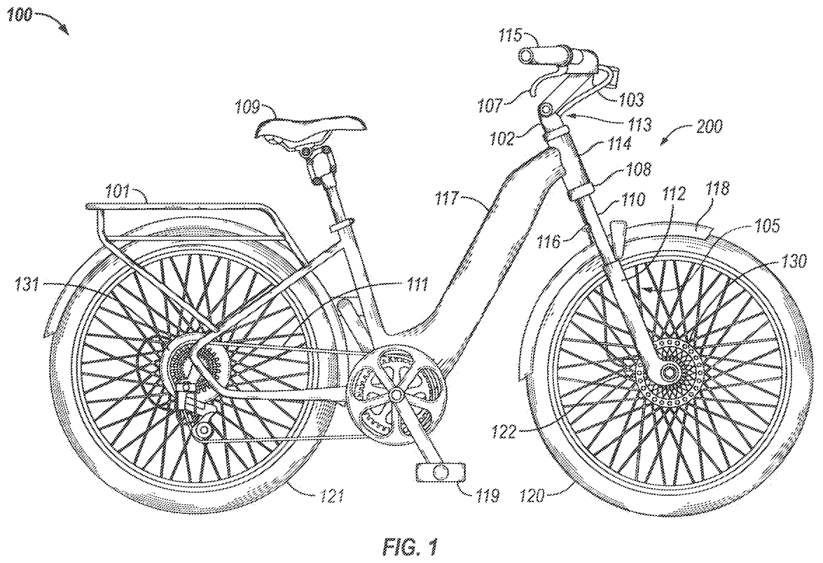

Referring first to FIG. 1, a rendering is provided of a vehicle configured with a fork assembly according to an illustrative embodiment of the disclosed principles. The vehicle in FIG. 1 is a bicycle 100 that includes a suspension fork assembly 200 connected to a frame 101. A rear wheel 121 is attached to the frame 101 and a front wheel 120 is attached to the fork assembly 200. A front fender 118 can be attached to the fork assembly 200 to cover the tire mounted on the front wheel 120. A similar fender can be provided for the rear wheel 121.

A rider (not shown) sitting on the seat 109 operates pedals 119 to provide a motive force that propels the bicycle 100 forward. In particular, the pedals 119 are engaged with a gearing system 111 that translates the pedaling force to the rear wheel 121. If the vehicle is configured as an e-bike, the downtube 117 can house a battery and motor. While the illustrated embodiment shows a bicycle 100, it should be understood that disclosed principles may also be employed with any type of similar vehicle, such as a motorbike, moped, motorcycle, scooter, tricycle, all-terrain vehicle (ATV), or any other type of vehicle having a similar front fork assembly 200 and associated steering and braking systems.

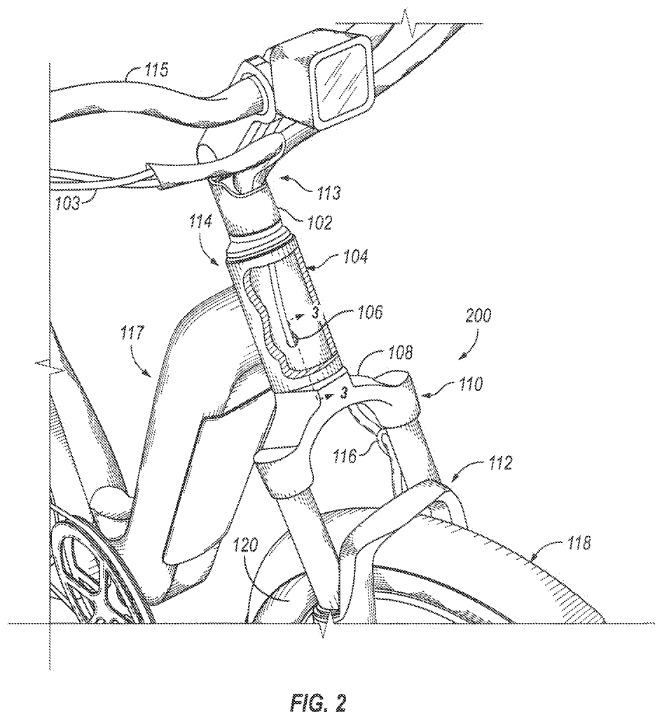

The fork assembly 200 includes a steer tube 104 (shown in FIG. 2) mounted coaxially within a head tube 114 that forms part of the frame 101. The head tube 114 rests atop a crown 108 of the fork assembly 200 and is rotatably coupled to the steer tube 104. A first end of the steer tube 104 is attached to an adjustable stem 102 that receives the handlebars 115. A second end of the steer tube 104 is attached to the crown 108 that is in turn attached to the pair of legs 105 of the fork assembly 200. Each of the pair of legs 105 is formed from a pair of stanchions 110 (i.e., “uppers”) connected to “lowers” 112. Suspension components (not shown) are housed within the legs 105 to allow the fork assembly 200 to absorb shock by the stanchions 110 slidably moving within the lowers 112 during such a shock. If the vehicle 100 is an electric bicycle, then the frame 101 may house or otherwise support a battery and an electric motor (not illustrated) that provides pedal assist.

The rider steers the vehicle 100 with the handlebars 115, which are securely fastened to the steer tube 104 by an adjustable stem 102 that can be adjusted to change the magnitude of the rotation angle. Rotation of the handlebars 115 in a generally clockwise or counterclockwise direction causes a concomitant rotation of the steer tube 104 and the front wheel 120.

The braking system includes at least one brake lever 107 coupled to the handlebars 115. In this illustrative embodiment in FIG. 1, the braking system includes two brake levers 107, each on opposing sides of the handlebars 115. A braking force applied to the brake levers 107 is translated to the brake disks 130 and 131, which are coupled to the front wheel 120 and the rear wheel 121, respectively. The brake lines 103 extend inwardly toward the adjustable stem 102 and are received into an aperture 113 to allow the brake lines 103 to be routed through the frame 101.

FIG. 2 is a partial cutaway view of the steer tube 104 of the fork assembly 200 positioned in the head tube 114 according to an illustrative embodiment of the principles disclosed herein. The front brake line 103 passes through an annular volume between the head tube 114 and the steer tube 104, and enters into the steer tube 104 through a channel 106 passing through the sidewall of the steer tube 104. The front brake line 103 then exits from the bottom end of the steer tube 104 and through one or more anchors 116 located on the rear face of one of the stanchions 110. The anchor 116 directs the front brake line 103 behind the stanchion 110 to a front brake caliper 122 (shown in FIG. 1) that clamps the brake disk 130 from the braking force applied to the brake lever 107. Internally routing the front brake line 103 provides more space for a front basket or front rack to be put on the bicycle 100. The front brake line 103 will also not interfere with a basket or platform when a rider turns the handlebars 115 of the bicycle 100.

The steer tube 104 of the front fork assembly 200 is coaxially aligned within the head tube 114, and is configured to receive at least one brake line 103 introduced through the adjustable stem 102 and into the annular region between the head tube 114 and the steer tube 104 before entering into a channel 106 in a sidewall of the steer tube 104. The brake line 103 then comes out the bottom of the steer tube 104 of the front fork assembly 200. This arrangement conceals the brake line 103 by routing it into the stem 102 and head tube 114. Providing the channel 106 in the steer tube 104 enables the brake lines 103 to be routed out the bottom of the head tube 104 without any braking issues caused by pinched brake lines. This configuration allows for the concealment of brake lines within the front fork assembly without needing a double-cylinder steer tube—the absence of which lowers weight and cost.

Routing the brake line 103 behind the fork assembly 200 using one or more rearward-facing anchors 116 improves aesthetics, safety, and aerodynamics. Aesthetically, routing the brake line 103 behind the front fork assembly 200 results in a cleaner appearance from the front of the vehicle 100 (shown in FIG. 1). Having the anchors 116 attached to the rear of the stanchion 110 enables the front brake line 103 to exit the steer tube 104 and go to the brake caliper 122 (shown in FIG. 1) with a hidden aesthetic. Safety-wise, placing the anchors 116 in the rear of the stanchion 110 pulls the front brake line 103 away from the front fender 118 and the moving front wheel 120. Attaching the front brake line 103 close to the front wheel 120 can be potentially dangerous. If there is too much slack in the front brake line 103 it can hit the front fork assembly 200 or get caught in the wheel 120 or front fender 118 and sever the front brake line 103. Additionally, the front brake line 103 could get caught or snagged on something when the vehicle 100 is in motion. Keeping the front brake line 103 separated from the front wheel 120 improves riding integrity. Finally, routing the front brake line 103 on the rear side of the one or more stanchions 110 improves aerodynamics, which results in improved riding efficiency.

Previous attempts at internal brake line routing have avoided routing front brake lines 103 through an internal bore of the steer tube 104 because of the likelihood of strain on the front brake line 103. Similarly, previous attempts at routing the front brake line 103 in an annular region between the head tube 114 and the steer tube 104 has resulted in strain on the front brake line 103. Using the double-cylinder method discussed above prevents strain on the front brake line 103 but requires additional material in the steer tube 104. In contrast, the front fork assembly 200 and front brake line 103 routing provided in accordance with the disclosed principles avoids brake line strain through the inclusion of the channel 106 in the steer tube 104. Routing the front brake line 103 through the channel 106 avoids the point of rotational contact between the head tube 114 and the crown 108. This point of contact produces high rotational forces that can sever the front brake line 103 that comes in contact with the two pieces. Avoiding these intense forces enables the front brake line 103 to be safely routed internally in the head tube 114.

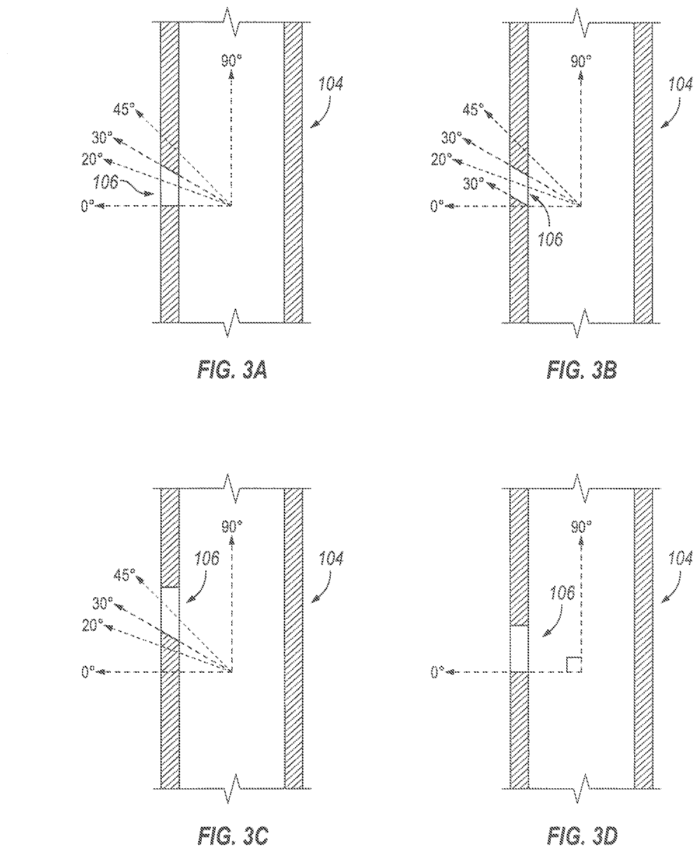

Referring next to FIGS. 3A-3D, renderings are provided of a cross-sectional view of the steer tube 104 with the channel 106. Each of the cross-sections are taken along line 3-3 in FIG. 2. In FIG. 3A, the channel 106 has a top edge that goes through the sidewall of the steer tube 104 at an angle approximately 30 degrees relative to a vector normal to the sidewall of the steer tube 104. The channel 106 has a bottom edge that is approximately parallel to a vector normal to the sidewall of the steer tube 104. In FIG. 3B, both the top and bottom edges are at an angle approximately 30 degrees relative to a vector normal to the sidewall of the steer tube 104. In FIG. 3C, the top edge is parallel to relative to a vector normal to the sidewall of the steer tube 104 and the bottom edge is at an angle approximately 30 degrees relative to the vector normal to the sidewall of the steer tube 104. In FIG. 3D, the top and bottom edges are parallel to a vector normal to the sidewall of the steer tube 104.

While an angle of approximately 30 degrees is shown in FIGS. 3A-3C, the angle can be in a range between 20 and 45 degrees above the crown 108 in some embodiments. The upward angle allows the brake line 103 to enter into the steer tube 104 more easily because the brake line 103 is vertically oriented within the head tube 114. The channel 106 shown in FIG. 3D is an alternative embodiment that is simpler to manufacture. In at least one embodiment, the channel 106 is about 6 mm in diameter. A channel 106 that is about 6 mm in diameter allows at least one brake line 103 to enter into the steer tube 104 without causing strain on the brake line 103. The channel 106 can also be sized to accommodate a desired quantity of a plurality of brake lines 103. Once the size of the channel 106 is large enough, such as at least 15 mm in diameter, a channel 106 with parallel edges may have the same strain-reducing benefits as one with an upward-facing angle.

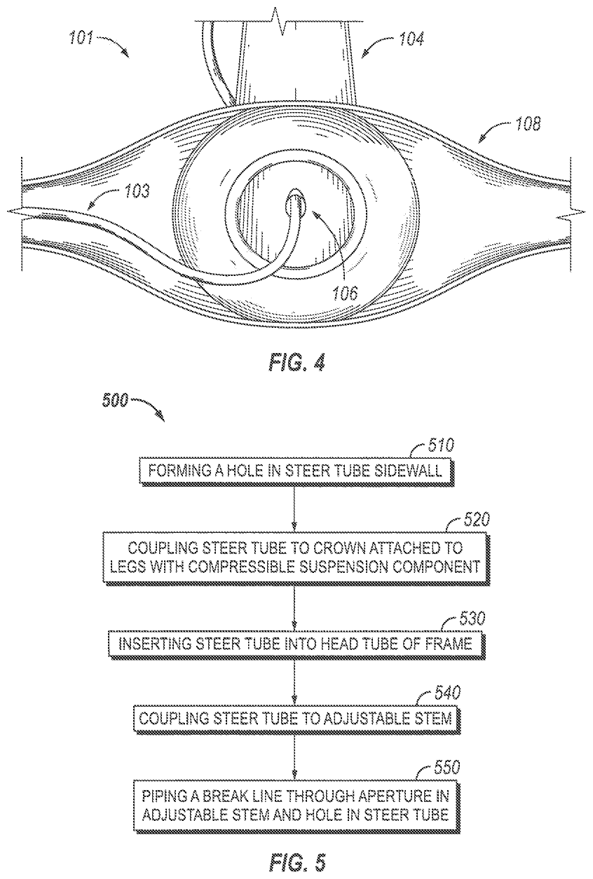

Referring next to FIG. 4, a rendering is provided of an underside view of the steer tube 104 of the front fork assembly 200 in accordance with an illustrative embodiment. The channel 106 can be formed in any portion of the sidewall of the steer tube 104. In at least one embodiment, the center of the channel 106 is about 30 mm above the second end of the steer tube 104. This configuration allows most of the front brake line 103 to route in an annular region between the head tube 114 and the steer tube 104, while still ensuring that the brake line 103 avoids a point of contact where the head tube 114 rotationally couples the crown 108. Placing the channel 106 closer to the crown 108 can allow for more brake line 103 flexibility because there is a longer stretch of flexible brake line 103 between the channel 106 and the brake lever 107. This longer stretch of flexible brake line 103 can allow the brake line 103 to bend and stretch more easily, and thus reduce the likelihood of pinching or severing.

Referring next to FIG. 5, a rendering is provided of a flowchart of a process 500 for assembling a steering assembly in accordance with an illustrative embodiment. The process 500 of assembling a steering assembly comprises: the step 510 of forming a channel in a sidewall of a steer tube, wherein the channel is sized to receive a brake line; the step 520 of coupling a second end of the steer tube to a crown attached to a set of legs housing a compressible suspension component; the step 530 of inserting the steer tube into a head tube of a frame; and the step 540 of coupling a first end of the steer tube to an adjustable stem.

Step 510 of forming the channel in the sidewall of the steer tube can further include drilling the channel at an angle of about 30 degrees relative to a vector normal to the sidewall of the steer tube. Step 510 can also further comprise drilling the channel at a location that is about 30 mm above the second end of the steer tube.

The process 500 can further comprise step 550 of piping at least one brake line through a front aperture in the adjustable stem; and piping the at least one brake line through the channel in the steer tube. Thus, the at least one brake line runs through the front aperture of the adjustable stem, between an annular region between the steer tube and the head tube, and into the channel in the steer tube. The brake line can also then be piped out the second end of the steer tube to a brake caliper attached to at least one of the set of legs housing the compressible suspension component.

Although embodiments of the inventive principles have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. For example, where this disclosure describes characteristics, structure, size, shape, arrangement, or composition for an element or process for making or using an element or combination of elements, the characteristics, structure, size, shape, arrangement, or composition can also be incorporated into any other element or combination of elements, or process for making or using an element or combination of elements described herein to provide additional embodiments.

Additionally, where an embodiment is described herein as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

While this invention has been particularly shown and described with reference to preferred embodiments, it will be understood by those skilled in the art that various changes in form and detail may be made therein without departing from the spirit and scope of the inventive principles. The inventors expect skilled artisans to employ such variations as appropriate, and the inventors intend the inventive principles to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the inventive principles unless otherwise indicated herein or otherwise clearly contradicted by context.

1. A suspension fork assembly, the assembly comprising:
a steer tube with a first end separated from a second end by an elongated body;
an adjustable stem at the first end, wherein the adjustable stem is configured to be securely fastened to handlebars; and
a set of legs connected to the second end by a crown, wherein:
the set of legs houses a compressible suspension component,
the adjustable stem includes an opening sized to receive at least a brake line,
the steer tube includes a channel extending through a sidewall of the steer tube and sized to receive the brake line into the steer tube.

2. The suspension fork assembly of claim 1, wherein:
the set of legs further comprises a corresponding pair of stanchions, each of which is connected at a first end to the crown and at a second end to a corresponding lower, and
at least one of the pair of stanchions houses the compressible suspension component.

3. The suspension fork assembly of claim 2, wherein at least one of the set of legs includes at least one rearward-facing bracket configured to route the brake line from the channel to a brake caliper along a rearward-facing side of the at least one of the set of legs.

4. The suspension fork assembly of claim 3, wherein each of the set of legs includes a plurality of rearward-facing brackets configured to route the brake line from the channel to a brake caliper on a rearward-facing side of the at least one of the set of legs.

5. The suspension fork assembly of claim 1, wherein the channel includes an edge that is at an angle between 20 and 45 degrees above the second end of the steer tube.

6. The suspension fork assembly of claim 5, wherein the channel includes an edge that is at an angle 30 degrees above the second end of the steer tube.

7. The suspension fork assembly of claim 1, wherein the channel is about 30 mm above the second end of the steer tube.

8. The suspension fork assembly of claim 1, wherein at least one of the set of legs includes at least one rearward-facing bracket configured to route the brake line from the channel to a brake caliper on a rearward-facing side of the at least one of the set of legs.

9. A vehicle comprising:
a fork assembly that includes:
a steer tube with a first end separated from a second end by an elongated body;
an adjustable stem at the first end, wherein the adjustable stem is configured to be securely fastened to handlebars; and
a set of legs connected to the second end by a crown, wherein:
each of the set of legs houses a compressible suspension component,
the adjustable stem includes an opening sized to receive at least one brake line, and
the steer tube includes a channel extending through a sidewall of the steer tube and sized to receive the brake line;
a frame including a head tube that is coaxially aligned with the steer tube;
handlebars connected to the adjustable stem; and
the brake line extending from the handlebars and passing into an annular region between the steer tube and the head tube, wherein the brake line enters the steer tube through the channel and exits from the second end.

10. The vehicle of claim 9, wherein:
the set of legs further comprises a corresponding pair of stanchions, each of which is connected at a first end to the crown and at a second end to a corresponding lower, and
at least one of the pair of stanchions houses the compressible suspension component.

11. The vehicle of claim 10, wherein at least one of the set of legs includes at least one rearward-facing bracket configured to route the brake line from the channel to a brake caliper on a rearward-facing side of the at least one of the set of legs.

12. The vehicle of claim 11, wherein the at least one of the set of legs includes a plurality of rearward-facing brackets configured to route a brake line from the channel to a brake caliper on the rearward-facing side of the at least one set of legs.

13. The vehicle of claim 9, wherein the channel includes an edge that is at an angle between 20 and 45 degrees above the second end of the steer tube.

14. The vehicle of claim 13, wherein the channel includes an edge that is at an angle 30 degrees above the second end of the steer tube.

15. The vehicle of claim 9, wherein the channel is about 30 mm above the second end of the steer tube.

16. The vehicle of claim 9, wherein at least one of the set of legs includes at least one rearward-facing bracket configured to route the brake line from the channel to a brake caliper on a rearward-facing side of the at least one of the set of legs.

17. A method of assembling a steering assembly, the method comprising:
forming a channel in a sidewall of a steer tube, wherein the channel is sized to receive a brake line;
coupling a second end of the steer tube to a crown attached to a set of legs housing a compressible suspension component;
inserting the steer tube into a head tube of a frame; and
coupling a first end of the steer tube to an adjustable stem.

18. The method of 17, wherein forming the channel further comprises drilling the channel at an angle of about 30 degrees relative to a vector normal to the sidewall of the steer tube.

19. The method of claim 17, wherein forming the channel further comprises drilling the channel at a location that is about 30 mm above the second end of the steer tube.

20. The method of 17, further comprising:
piping at least one brake line through a front aperture in the adjustable stem; and
piping the at least one brake line through the channel in the steer tube.
